(19) United States
(12) Patent Application Publication
(10) Pub. No.: US 2006/0288361 A1
(43) Pub. Date: Dec. 21, 2006

(54) In a system for receiving and storing data representative of a plurality of broadcast television progams, an implementation for locating replacement portions for defective portions of stored programs from other broadcasts of corresponding television programs

(76) Inventors: Brian L. White Eagle, Austin, TX (US); Sarah V. White Eagle, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/154,902

(22) Filed: Jun. 16, 2005

(51) Int. Cl. H04N 7/025; H04N 7/10

(52) U.S. Cl. 725/32; 725/34; 725/35

(57) ABSTRACT

A computer controlled interactive television system comprising receiving apparatus for and storing a transmitted data stream representative of television programs of defined duration originally broadcast at defined times comprising apparatus for receiving and storing the transmitted data, a television display in combination with apparatus enabling a user to select the presentation of one of said stored television programs on the television display and apparatus responsive to a user selection of a stored program for presenting the selected television program on the television display. This is representative of a standard PVR or DVR operation. The invention then provides apparatus for detecting a defective transmission of at least a portion of a received television program, combined with apparatus, responsive to the detection of the defective transmission of a received television program, for locating another broadcast of the defectively transmitted television program together with apparatus for transmitting a substitute portion of the another broadcasted program corresponding to the defectively transmitted portion and apparatus for replacing the defectively transmitted portion with said substitute portion in the stored defectively transmitted television program.

### TECHNICAL FIELD

The present invention relates to Personal Video Recorders (PVRs), also known as Digital Video Recorders (DVRs) and, particularly, to enhanced functions for such recorders.

### BACKGROUND OF RELATED ART

The past decade has been marked by a technological revolution driven by the convergence of the data processing industry with the consumer electronics industry. An area where this relationship has been advantageous is that of digital video recording. This has resulted in the emergence of a set top box based upon the PVR, also marketed as DVRs. A description of the PVR and like digital video recorders and their increasing consumer functions as computer controlled “engines” in television set top boxes may be found in: IEEE Spectrum periodical, (IEEE Inc.), New York, N.Y., July 2002, at pp. 26-31. The PVR has many advantages, particularly ease of use to the users in the advance scheduling of television programs to be subsequently sequentially recorded

The present invention relates to a unique function of PVRs with respect to data streams of television programming provided by television service providers, such as cable, e.g. cablevision or satellite television service providers. In order to better appreciate this invention, the background of such cable and satellite services needs to be considered. As the demand for television programming rapidly increased, frequency channels that the Government made available for the presentation of programming by respective television stations also rapidly increased. This led to television service providers that obtained and consolidated the programs transmitted by the respective television stations to be presented to viewers at Government designated frequency channels. The original television stations would transmit at their assigned frequencies either by direct line of sight, cable or through satellites. The television service providers then received the respective program channel signals and consolidated all the data in such transmissions into an integrated data stream representative of an extensive set of television programs being presented on corresponding channels into an unitary data stream that was then compressed and transmitted to the television service provider's subscribers either via satellite or cable. This integrated data stream was encrypted to protect the provider's revenues. The viewer could then receive this integrated data stream and extract any “live” or real-time television program through his conventional television frequency channel tuner. The provider system would extract the appropriate television program data directly from the real-time satellite of cable service provider integrated data stream. The extracted program data would be decrypted and decompressed and the television program would be displayed on a real-time basis on the television set display.

Where the user wished to record a particular television program for future viewing, it would be extracted at its scheduled viewing period from the integrated data stream in the same manner as described, decrypted, decompressed and recorded on disk drives (DVD). Individual programs on their respective channels could still be recorded on a real-time basis by first extracting, decrypting and decompressing.

This, of course, resulted in the current state of the DVR or PVR industry where the user, with an appropriate PVR, could record dozens of broadcast and transmitted television programs for future viewing merely by entering its unique identifier.

Of course, with the great popularity and marketing of PVRs, the industry is continually seeking improved functions for the devices. The present invention provides a significant new function for PVRs.

### SUMMARY OF THE PRESENT INVENTION

The present invention expands the function of PVRs to provide a remedy for defective transmissions of broadcast scheduled television programs. It does occasionally occur that defective portions of broadcast television are transmitted and, thus, recorded and stored on the PVRs. This may be due to faults in the original live broadcast or more likely due to defects in the satellite and even cable transmissions distributing the broadcasts to receiving users, particularly users who are subscribers to satellite and/or cable service providers.

The present invention is based on the recognition that with the extensive national networks maintained by service providers wherein each broadcast program already has an unique identifier, and corresponding television programs are broadcast and transmitted to receiving users in different parts of a country or even the world at different times, that it should be possible to locate a television program corresponding to the defectively transmitted television program stored in the PVR at the receiving user, and to replace all or a portion of the stored defectively transmitted television program.

Accordingly, the present invention involves a computer controlled interactive television system comprising receiving apparatus for and storing a transmitted data stream representative of said plurality of television programs of defined duration originally broadcast at defined times comprising apparatus for receiving and storing said transmitted data, a television display in combination with apparatus enabling a user to select the presentation of one of the plurality of stored television programs on the television display, and apparatus responsive to a user selection of a stored program for presenting the selected television program on the television display. This is representative of a standard PVR or DVR operation. The invention then provides apparatus for detecting a defective transmission of at least a portion of a received television program, combined with apparatus, responsive to the detection of the defective transmission of a received television program, for locating another broadcast of the defectively transmitted television program together with apparatus for transmitting a substitute portion of the another broadcasted program corresponding to the defectively transmitted portion, and apparatus for replacing the defectively transmitted portion with said substitute portion in the stored defectively transmitted television program.

The system preferably involves a retransmission or rebroadcast identical with the original of the defectively transmitted program. The system operates particularly effectively where there is apparatus at a service provider for recording at least another broadcast of each of a plurality of television programs identical with an originally broadcasted television program; and the apparatus for locating another broadcast transmits the recorded another broadcast or a portion thereof of a television program identical with the original of the defectively transmitted program as a substitute for the defectively transmitted program.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a landscape illustrative of how data streams of data representative of a set of television programs are gathered, organized and distributed by both cable and satellite transmission television service providers;

FIG. 2 is a generalized view of how the system of the present invention is organized around a PVR;

FIG. 3 is a flowchart describing how the data stream system of the present invention provides for the storage of such data streams and for the location of television programs corresponding to defectively transmitted user stored television programs, and for the substitution of nondefective portions from the corresponding located television programs; and

FIG. 4 is a flowchart of an illustrative run of a process set up in FIG. 3.

### DETAILED DESCRIPTION OF THE PREFERRED EMBODIMENT

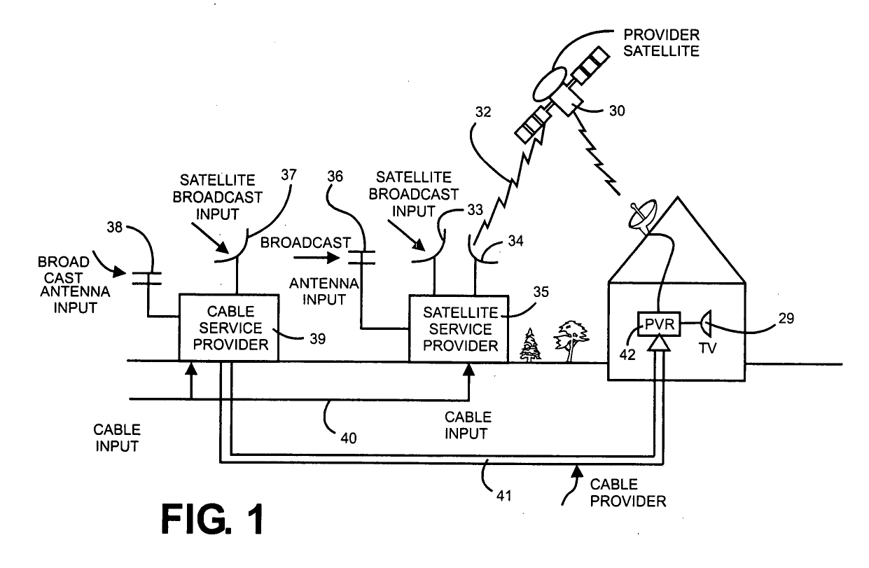

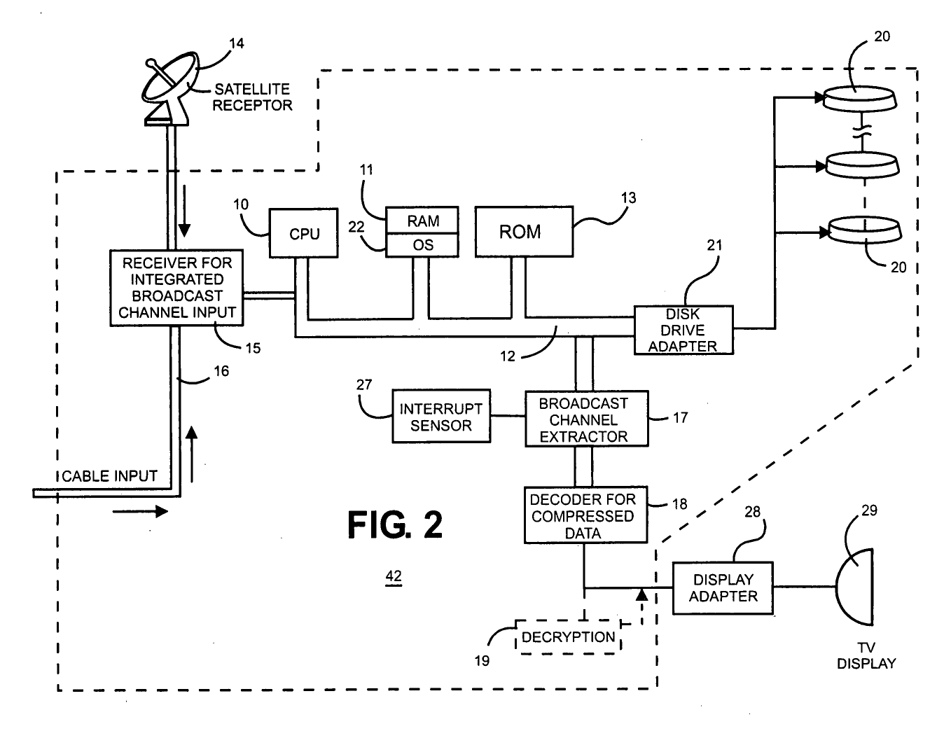

Referring to FIG. 1, there is shown a generalized landscape diagram to illustrate the current standard provision of integrated unitary data streams representative of an extensive plurality of television programs presentable on a corresponding plurality of assigned frequency television channels licensed to television stations for the presentation, i.e. broadcast of television programs. Accordingly, a typical cable, e.g. cablevision service provider 39, gathers in television program data signals from various broadcast signals, e.g. satellite broadcast input 37, cable broadcast input 40 and traditional line of sight input 38. Similarly, a typical satellite TV service provider 35 gathers in television program data signals from similar broadcast signals, e.g. satellite broadcast input 33, cable broadcast input 40 and traditional line of sight input 36. The cablevison television service provider 39 then consolidates all of these inputs into a continuous integrated data stream signal representative of all of the television programming respectively scheduled for each assigned frequency channel for each time period that, at the present state of the art, involves hundreds of channels. At present, this integrated data stream may be segmented into several integrated data stream segments, each representative of a particular type or body of programming available on a corresponding set of frequency channels, e.g. a movie film set, a sports set, a family entertainment set, etc. Such integrated data stream segments may be made up of as much as 50 to 100 channel programs scheduled for simultaneous presentation. The cable service provider then compresses and encrypts the integrated data stream and distributes via transmission on cable 41 to the home of the subscriber where it is handled, for illustration of the present invention by PVR 42 and presented on TV set 29, as will hereinafter be described in greater detail with respect to FIG. 2. A similarly integrated data stream signal 32 is sent from satellite provider 35 via antenna 34 to a fixed position provider satellite 30 from which it is returned as integrated data stream signal 31 to PVR 42.

Now, with respect to FIG. 2, the operations on the PVR 42 will be described. The apparatus shown may be conveniently housed in a television set top box. Satellite receptor antenna 14 receives the integrated data stream that is applied to a standard receiver for integrated broadcast channel input 15. Similarly, the integrated data stream from cable may be applied through input 16 to receiver 15.

The operations involved in the present invention are controlled by a data processing system under the control of a central processing unit 10, which, in turn, is interconnected to various other components by system bus 12. An operating system 22 that runs on processor 10 provides control and is used to coordinate the functions of the various components of the control system. The OS 22 is stored in Random Access Memory (RAM) 11. The programs for the functions, including those of the present invention, are permanently stored in Read Only Memory (ROM) 13 and moved into and out of RAM to perform their respective functions. In the normal operation for real-time television program playing, the integrated incoming data stream, under CPU control, is applied to broadcast channel extractor 17 that extracts the data representative of the television program scheduled for the channel that the user has conventionally tuned to on a tuner (not shown) and applies the extracted data to decoder 18 where it is decompressed. Also, since the data is likely to be encrypted to commercially protect the provider, encrypted data is optionally put through conventional decryption means 19 and then applied to a conventional television display adapter 28 to be displayed on the user's television set 29.

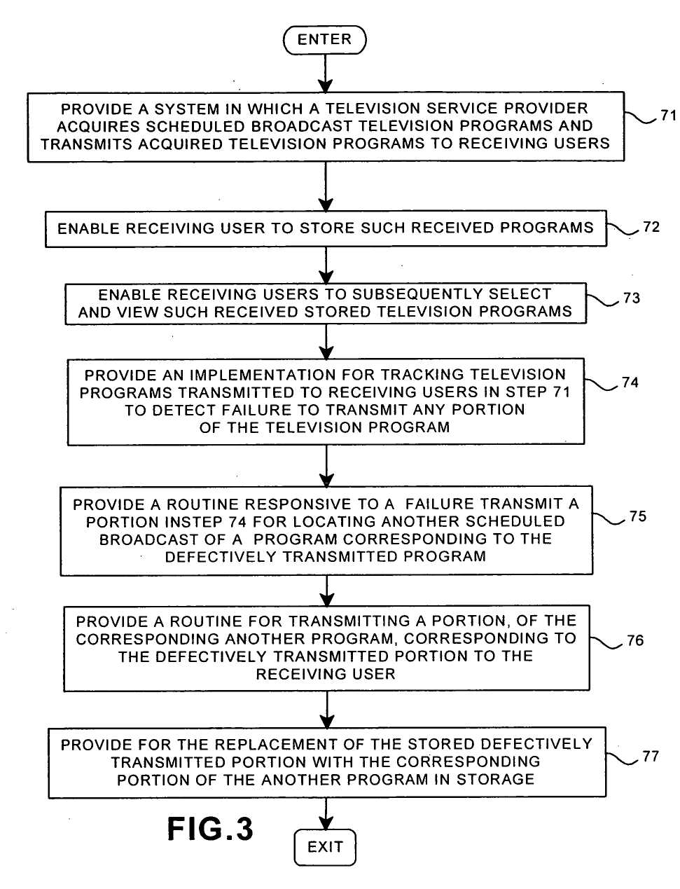

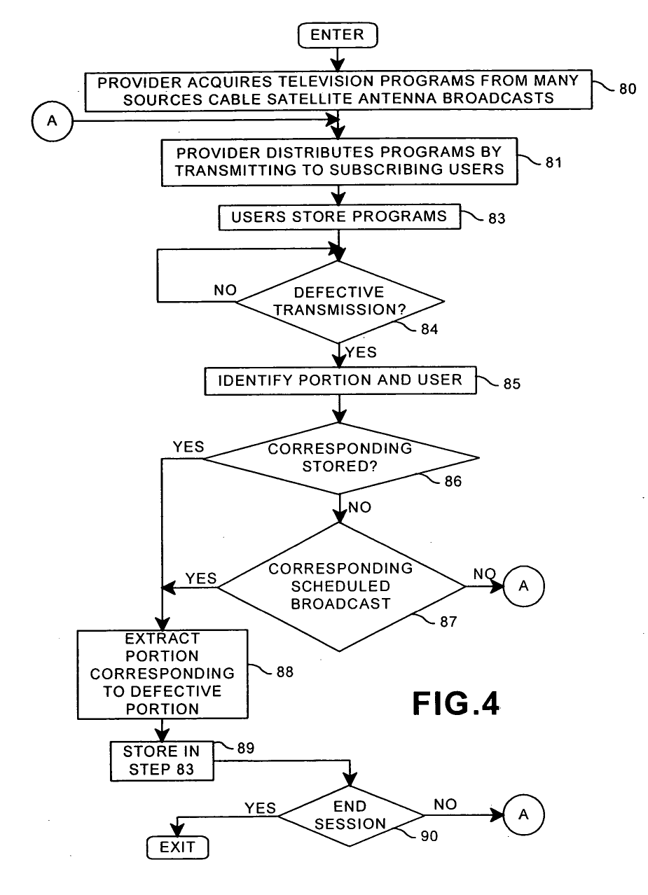

There will now be considered the recording of the incoming unitary integrated data stream. It is done through a disk drive system via disk drive adapter 21 on disk drives 20 of the PVR or DVR. In the conventional operation of a PVR, the television program scheduled for a given channel at a given time would be extracted by extractor 17, decompressed on decoder 18, decrypted and then stored on the single disk drive provided on the PVR. This individual program would be recorded and, thus, stored on the disk drive either in response to either advance scheduling by the user for such a recording or a user request to record a real-time presented television program. In this environment, sensing apparatus, interrupt sensor 27 may be set up in association with the broadcast channel extractor for sensing unscheduled interrupts in the broadcast including the frequency and duration of such interrupts. Based on the sensed data, a determination may be made as to the length of the defective portion in the stoked defective transmitted broadcast. Then, as will hereinafter be described in greater detail with respect to FIGS. 3 and 4, the defective portion of the stored broadcast program will be replaced by locating a corresponding television program scheduled to be subsequently broadcast or previously broadcast and stored. Then, the appropriate substitute portion, which could be the whole broadcast television program if it was entirely defectively transmitted, is transmitted to the apparatus of FIG. 2, extracted via extractor 17, and substituted at the appropriate disk in disk drive 20, hopefully, transparently to the receiving user and before the user has selected to view the stored television program.

Now, with reference to the programming shown in FIG. 3, there will be described how the system and programs of the present invention are set up. There is provided a basic service provider system in which there is transmitted an integrated data stream of a plurality of television programs acquired by the service provider as described with respect to FIG. 1 presentable on a corresponding plurality of television channels, e.g. cable or satellite TV, with provision made for the reception and storage of selected programs from the data stream at the receiving television unit, step 71. The user is enabled to receive and store such television programs, step 72. From these programs stored on his DVR, the user in enabled to select and subsequently view the stored television programs, step 74. In this environment, there is provided an implementation for tracking transmitted television programs to receiving users in step 71 to detect failure to transmit any portion of any received television program, step 75. In the case of a failure to transmit a portion of a program in step 74, there is provided, step 75, a routine for locating another scheduled broadcast of a program corresponding to the defectively transmitted portion which was received by the user. Once the corresponding television program is located, a routine is provided for transmitting to the user the portion of the located other program that corresponds to the defectively transmitted portion, step 76. Then provision is made for the replacement of the then stored defectively transmitted portion by the corresponding portion of the another television program, step 77.

Now, with reference to the flowchart of FIG. 4, a simplified illustrative run of the process set up in FIG. 3 will be described. The service provider conventionally acquires television programming from many sources: cable, satellite and straight line antennae broadcasts, step 80. The provider distributes the programs by transmitting them and distributing as described above, step 81. The users store the television programs in their DVRs, step 83. A determination is made as to whether the transmission is defective, step 84. If No, the transmission is not defective, then the transmission continues. If Yes, there is a defective transmission, then the portion defective and the user are identified, step 85, and a search is made by the service provider for a corresponding program that may already be stored in the provider system, step 86. If No, a search by provider is made to locate a corresponding program scheduled broadcast, step 87. If No at this point, then a corresponding broadcast cannot be located, and the distribution operation continues as the branch via “A” to step 81 indicates. The user in this case cannot replace the defective portion of his stored program. However, if a corresponding television program broadcast can be located, i.e. a Yes from either step 86 or 87, then step 88, the portion corresponding to the defective portion is extracted, and step 89 transmitted to and substituted in the DVR of the receiving user of step 83. At this point, a determination may conveniently be made as to whether the session of television program storage is at an end, step 90. If Yes, the session is exited. If No, the session is branched via “A” to step 81.

The following is a simplified illustrative set of programming instructions in pseudocode showing how a corresponding television program broadcast may be located and an appropriate portion extracted and substituted for the defective portion in the DVR that received the defective program transmission.

### Example of Programming Instructions (Pseudocode)

Assign alphanumerical identifiers to each broadcast television programs (letters, A, B, etc. may be assigned to corresponding programs broadcast different times.)
   Provide a time line in each broadcast television program.
   Provide a schedule of all television programs broadcast over a selected time period. (may include leads to stored recordings of previously broadcast programs)
   Provide routine at receiving user to detect and define defective transmission portions in stored television programs.
   Provide routine associated with receiving user to locate corresponding television program through the schedule.
   Provide routine for extracting portion corresponding to defective portion from located corresponding program.
   Transmit extracted portion to receiving user, and substitute portion in the defective stored television program.

Although certain preferred embodiments have been shown and described, it will be understood that many changes and modifications may be made therein without departing from the scope and intent of the appended claims.

What is claimed is:

1. A computer controlled user interactive system for receiving and storing transmitted data representative of a plurality of television programs of defined duration originally broadcast at defined times comprising:
apparatus for receiving and storing said transmitted data;
a television display;
apparatus enabling a user to select the presentation of one of said plurality of stored television programs on said television display;
apparatus responsive to a user selection of a stored program for presenting said selected television program on said television display;
apparatus for detecting a defective transmission of at least a portion of a received television program;
apparatus, responsive to the detection of said defective transmission of a received television program, for locating another broadcast of the defectively transmitted television program;
apparatus for transmitting a substitute portion of the another broadcasted program corresponding to said defectively transmitted portion; and
apparatus for replacing said defectively transmitted portion with said substitute portion in the stored defectively transmitted television program.

2. The system of claim 1 wherein the apparatus for receiving and storing the transmitted data is a digital video recorder.

3. The system of claim 2 wherein said transmitted data is transmitted via satellite.

4. The system of claim 2 wherein said transmitted data is transmitted via cable.

5. The system of claim 2 wherein said another broadcast of said defectively transmitted program is a rebroadcast identical with the original of the defectively transmitted program.

6. The system of claim 5 further including apparatus at a service provider for recording at least another broadcast of each of a plurality of television programs identical with an originally broadcast television program; and
said apparatus for locating another broadcast transmits said recorded another broadcast or a portion thereof of a television program identical with the original of the defectively transmitted program as a substitute for the defectively transmitted program.

7. A computer controlled user interactive method for receiving and storing transmitted data representative of a plurality of television programs of defined duration originally broadcast at defined times so that a user may selectively subsequently show such programs on an associated television display comprising:
receiving and storing said transmitted data;
enabling a user to select the presentation of one of said plurality of stored television programs on said television display;
presenting a selected television program on said television display responsive to a user selection of a stored program;
detecting a defective transmission of at least a portion of a received television program;
responsive to the detection of said defective transmission of a received television program, for locating another broadcast of the defectively transmitted television program;
transmitting a substitute portion of the another broadcasted program corresponding to said defectively transmitted portion; and
replacing said defectively transmitted portion with said substitute portion in the stored defectively transmitted television program.

8. The method of claim 7 wherein the transmitted data is received and stored on a digital video recorder.

9. The method of claim 7 wherein said transmitted data is transmitted via satellite.

10. The method of claim 7 wherein said transmitted data is transmitted via cable.

11. The method of claim 7 wherein said another broadcast of said defectively transmitted program is a rebroadcast identical with the original of the defectively transmitted program.

12. The method of claim 11 further including the step of recording at a service provider at least another broadcast of each of a plurality of television programs identical with an originally broadcasted television program; and
said step of locating another broadcast transmits said recorded another broadcast or a portion thereof of a television program identical with the original of the defectively transmitted program as a substitute for the defectively transmitted program.

13. The method of claim 7 wherein each broadcast television program and rebroadcast of the same television program share the same unique identifier, said identifier being used to locate said another broadcast.

14. The method of claim 7 wherein said another broadcast of said defectively transmitted television program is from a source different from the source broadcast of the defectively transmitted television program.

15. A computer program having code recorded on a computer readable medium for a computer controlled display system for receiving and storing transmitted data representative of a plurality of television programs of defined duration originally broadcast at defined times whereby the user may subsequently selectively display any of said stored television programs comprising:
means for receiving and storing said transmitted data;
means enabling a user to select the presentation of one of said plurality of stored television programs on said television display;
means responsive to a user selection of a stored program for presenting said selected television program on said television display;
means for detecting a defective transmission of at least a portion of a received television program;
means, responsive to the detection of said defective transmission of a received television program, for locating another broadcast of the defectively transmitted television program;
means for transmitting a substitute portion of the another broadcasted program corresponding to said defectively transmitted portion; and
means for replacing said defectively transmitted portion with said substitute portion in the stored defectively transmitted television program.

16. The computer program of claim 15 wherein the apparatus for receiving and storing the transmitted data is a digital video recorder.

17. The computer program of claim 16 wherein said transmitted data is transmitted via satellite.

18. The computer program of claim 16 wherein said transmitted data is transmitted via cable.

19. The computer program of claim 16 wherein said another broadcast of said defectively transmitted program is a rebroadcast identical with the original of the defectively transmitted program.

20. The computer program of claim 16 further including apparatus at a service provider for recording at least another broadcast of each of a plurality of television programs identical with an originally broadcasted television program; and
said apparatus for locating another broadcast transmits said recorded another broadcast or a portion thereof of a television program identical with the original of the defectively transmitted program as a substitute for the defectively transmitted program.
